(19) United States
(12) Patent Application Publication
(10) Pub. No.: US 2017/0213069 A1
(43) Pub. Date: Jul. 27, 2017

(54) HANDWRITING ANALYSIS TEST WITH OBSTACLE TO VISA SIGNATURE WITH A NAKED EYE

(71) Applicant: JUAN MIGUEL GIRON ESPON, MIAMI BEACH, FL (US)

(72) Inventors: JUAN MIGUEL GIRON ESPON, GUATEMALA (GT); MARIA ANDREA GIRON ESPON, GUATEMALA (GT); JAIME OVIDIO GIRON ESPON, JR., GUATEMALA (GT); CLARA LUZ ESPON REYES DE GIRON, GUATEMALA (GT); JAIME OVIDIO GIRON CABRERA, SR., GUATEMALA (GT)

(21) Appl. No.: 15/330,888

(22) PCT Filed: Jul. 14, 2014
(86) PCT No.: PCT/GT14/00001

§ 371 Date: Jan. 13, 2017

(51) Int. Cl. G06K 9/00; B42D 25/318

(52) U.S. Cl. CPC G06K 9/00154; B42D 25/318

(57) ABSTRACT

Analysis of questionable signatures, with prevention of imitating signatures according to the modern celerity to accept or deny as valid a signature affixed on any kind of document with alphanumeric reference or without alphanumeric reference, by authenticating it with the naked eye and evaluating for such purpose a signature affixed on one or more obstacle(s) of any geometric shape and of any kind of material and any color, which are placed and stuck on the document to be signed or on another external support to the document to be authenticated, and such obstacle(s) impede the normal stroke of the ink instrument with which the signature is written, and the structure resulting from the signature over the obstacles is collated with the structure of the questionable signature and/or with the structure of the signature considered as indubitable.

### BACKGROUND OF THE INVENTION

The present invention relates to analysis of a signature, and more particularly, to analysis of a hand-written signature using a method of affixing one or more obstacles on a document which is to be signed so that the obstacles interrupt the normal stroke of the ink instrument, to allow quick and accurate validation or invalidation of the signature by persons who are not experts in handwriting analysis.

The purpose of the present invention is to make known the precision conformity or disconformity of a handwritten signature in order that the person who does not have the theoretical and technical knowledge of an expert in calligraphy analysis of questionable signatures can be able to act carefully and, with prevention according to the modern celerity, to accept or deny as valid a signature affixed in any kind of document with alphanumeric reference or without alphanumeric reference, in any language or at any time, by visaing it with the naked eye and evaluating for such purpose a signature affixed on one or more obstacle(s) of any geometrical shape and of any kind of material or any color, which was/were placed and stuck to a place to be signed in the document to be visaed or on another external support in a place to be signed in the document to be visaed, such obstacle(s) impeding the normal stroke of the ink instrument with which the signature is written, and whose structure resulting from the signature over the obstacles is collated with the structure of the questionable signature and/or with the structure of the signature considered as indubitable.

Today, in any environment of human activity in which, when any kind of document requires a signature for authenticity or approval of its content, the document is visaed by a person (signature inspector) who, with the naked eye, has to accept a signature as authentic, or deny it as a doubtful signature.

Currently, the signature inspector does not have any procedure in place that would make notorious the precision conformity or disconformity in the signature structure affixed to the document, and the signature inspector only has his/her experience and may not be a handwriting analysis expert, and so would not be able to promptly and accurately make the decision to accept or deny the signed document. Currently, in the analysis of the structure of a signature, there is no obstacle used that impedes the normal stroke of the ink instrument with which the signature is written. Documents that require signatures are free of obstacles in the moment before-signature and in the moment it is signed.

However, the person who is responsible for authenticating with the naked eye at any moment any kind of document in any language that is required to be signed is now able to analyze if the signature affixed to such a document can be accepted as valid or can be denied if it is a doubtful signature. The claimed invention allows it to be well known to anyone if the signature is authenetic or invalid by collating it in situ with the one that is considered as an indubitable signature. The present invention uses for such analysis one or more obstacle(s) that produces one or more step(s) over which the evaluated signature must be signed, which obstacle(s) can be considered also as “a priori”, “in situ” and “a posteriori” instruments for expert handwriting analysis of a signature.

### SUMMARY OF THE INVENTION

The invention consists of steps to make notorious the precision conformity or disconformity of a hand-written signature in order that the person who does not have the theoretical and technical knowledge of an expert in calligraphy analysis of questionable signatures be able to act carefully, and with prevention according to the modern celerity, to accept or deny as valid a signature affixed to any kind of document with alphanumeric reference or without alphanumeric reference by visaing it with the naked eye to evaluate the signature for such purpose when a signature is affixed to one or more obstacle(s) of any geometric shape, and of any kind of material or color, which are manually or mechanically placed and stuck on a document required to be signed in order for the signature to be visaed, or on another external support to the document required to be signed in order for the signature to be visaed, where such obstacle(s) impede the normal stroke of the ink instrument with which the signature is written, and whose structure resulting from the signature over the obstacles is collated with the structure of the questionable signature and/or with the structure of the signature that is considered as indubitable.

In the procedure of the present invention, the obstacles produce difficulty when the signature is affixed, causing stops and shaking in the handwriting graphic path that constitutes the particular features and fundamental factors of the handwriting calligraphy identity of the original signer, and the physical resistance caused by such obstacles, and the physical resistance of the obstacles caused by the invention when the signature is repeated, can be corrected only by the original signer, so the invention makes it clear that, if there are dissimilarities, divergences and coincidences in the natural performance from the beginning to the end of the hand-written signature, that allows a person who is not an expert to be able to conclude in situ the morpho-dimension of the evaluated signatures are or are not affixed by the same person.

The invention allows the signature inspector to observe the signature with the naked eye and assess directly, in real time, whether or not there are resemblances or similarities with the authentic signature, and therefore he/she can deny or authorize the document submitted to be visaed, without relying on being a handwriting expert in any moment in time.

The invention is intended to prevent fraud in its fullest extent by analyzing with the naked eye a questionable signature and being able to conclude if it is to be denied or accepted, in real time, and without being an expert in the field.

An embodiment of the claimed procedure to authenticate at any moment any kind of document in any language with alphanumeric reference or without alphanumeric reference, which requires the authorization or approval of its content through the hand-written signature of a person, is by collating an indubitable signature against the one signature affixed in situ on the obstacle(s) placed and stuck on a spot of the document to be visaed or in another external support of the document to be visaed.

### BRIEF DESCRIPTION OF THE DRAWINGS

FIG. 1A represents a document with the signature stamped in the normal space; FIG. 1B represents a document with the signature stamped on an obstacle; and FIG. 1C represents some ink instruments to sign.

FIG. 2A represents three different types of the organization of the desktop space of the ductus that can be Wood, glass, metal and others; FIG. 2B depicts a desk space of the ductus where the signature is seated; FIG. 2C shows a space ductus desk where the signature is standing.

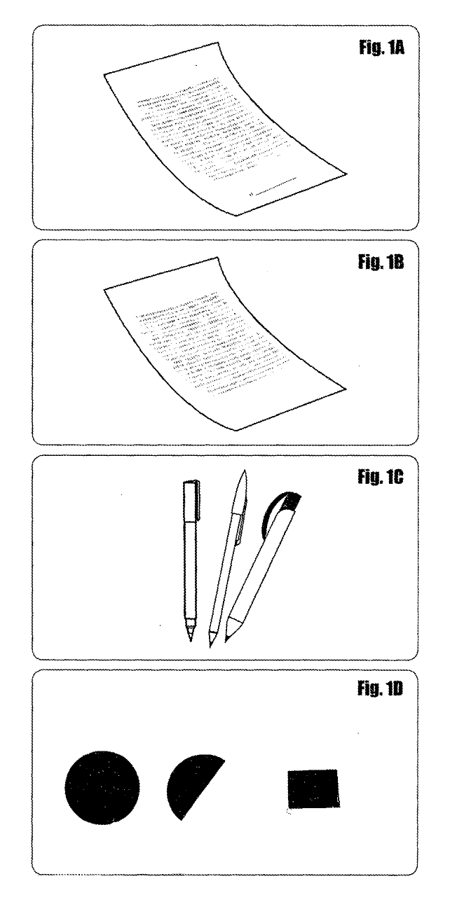

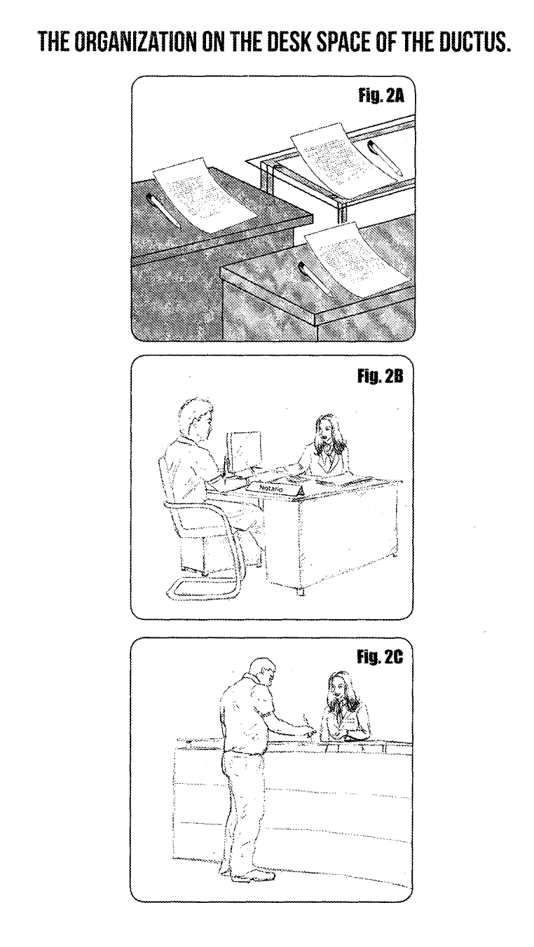

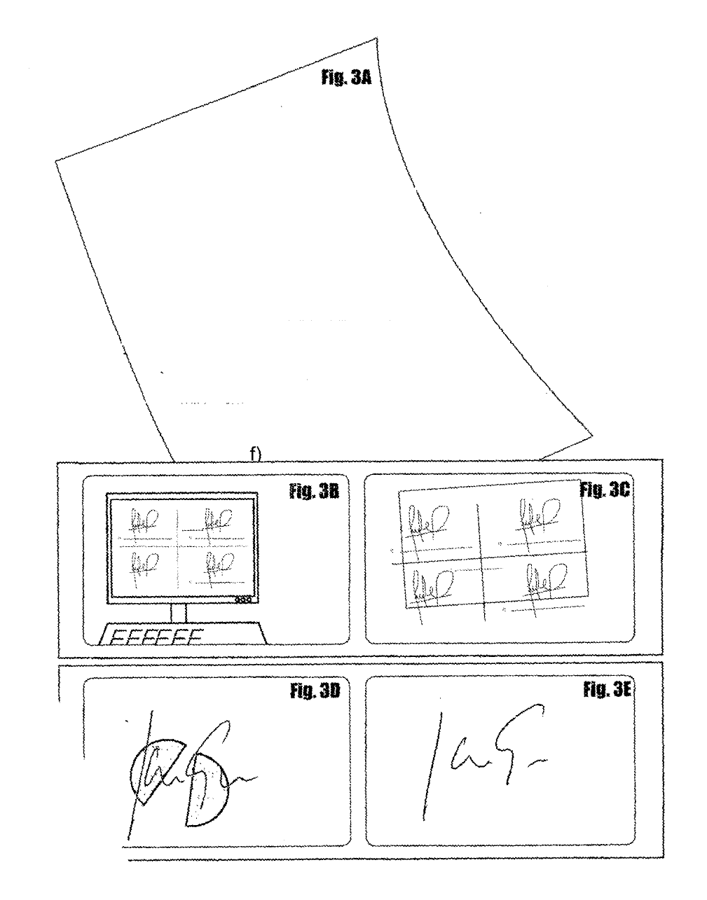

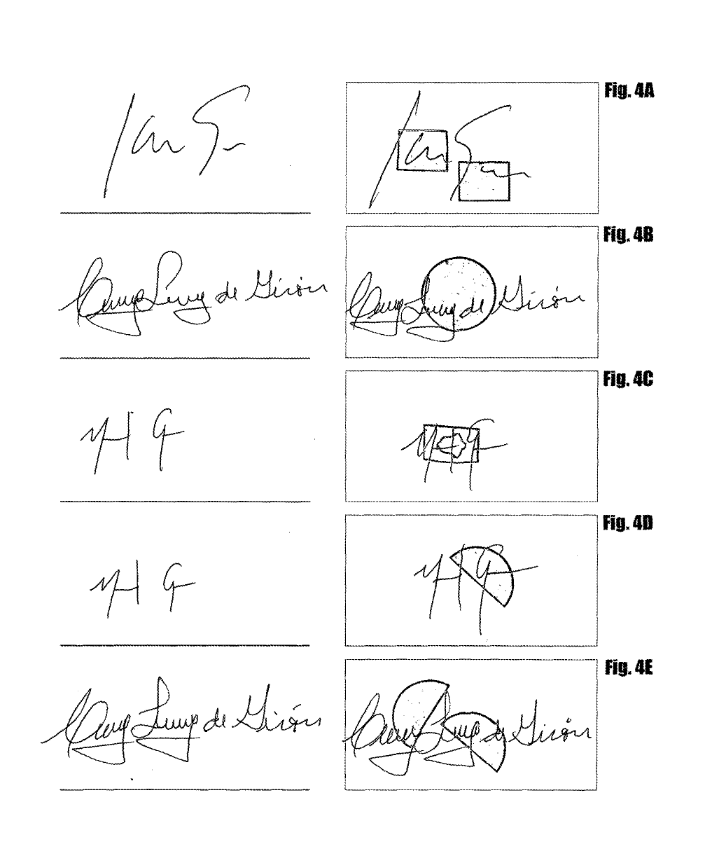

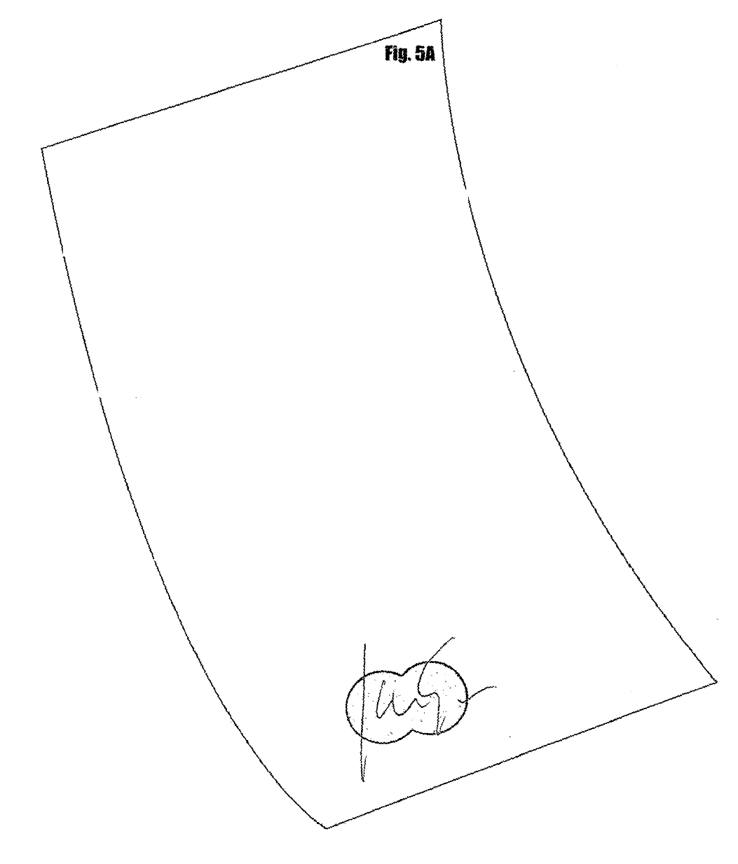

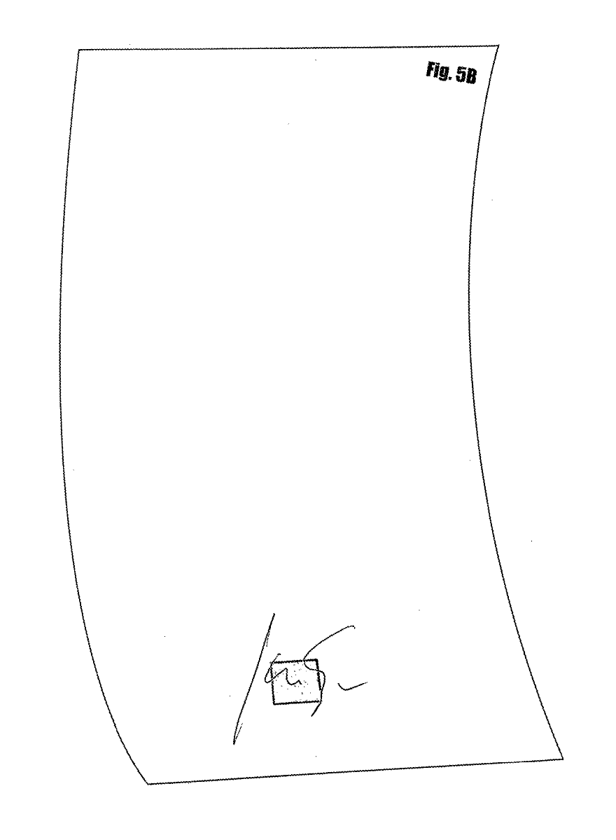

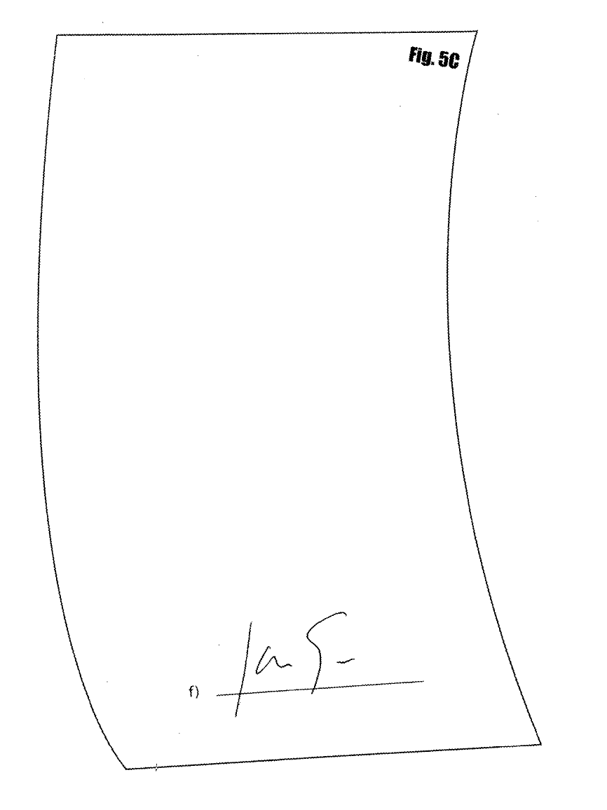

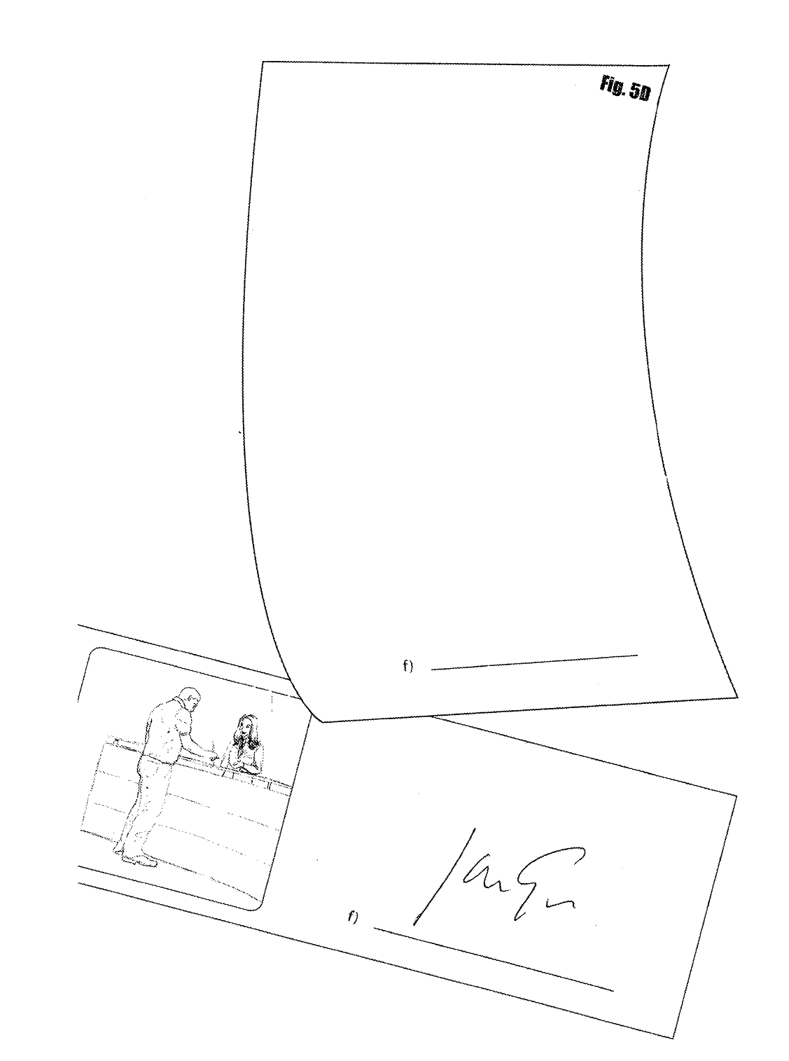

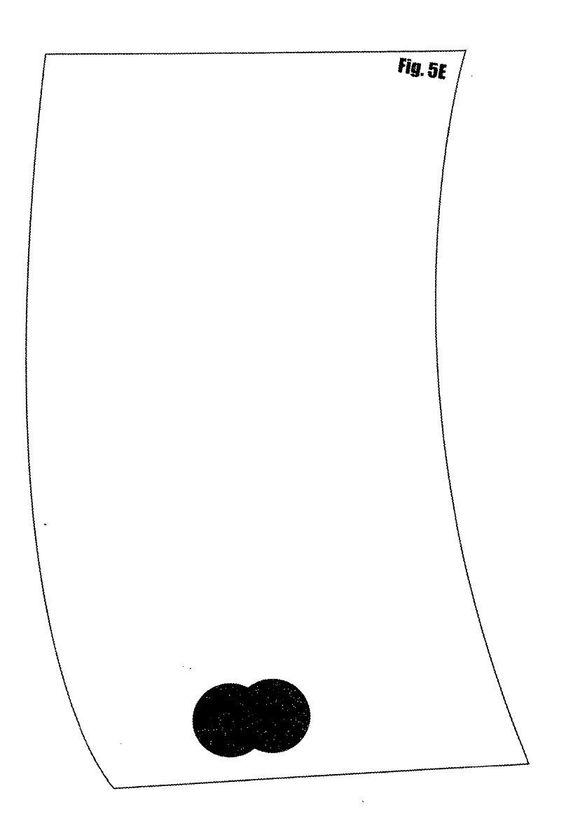

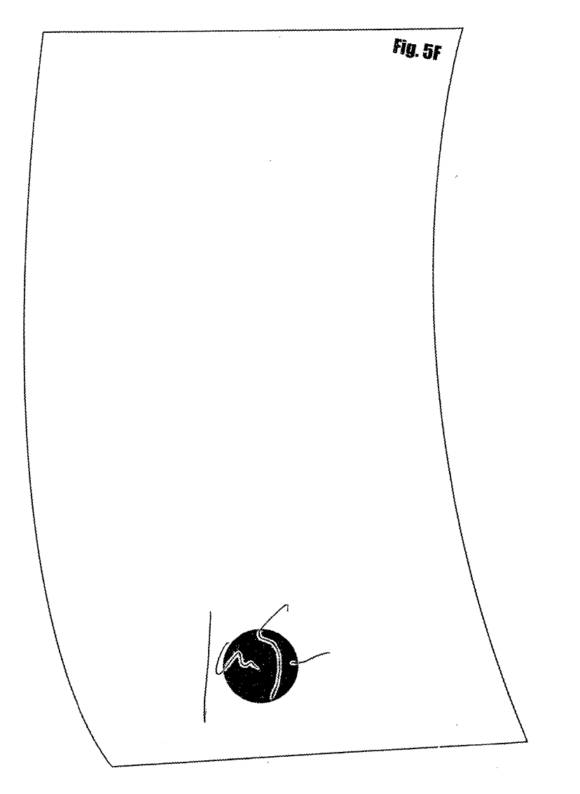

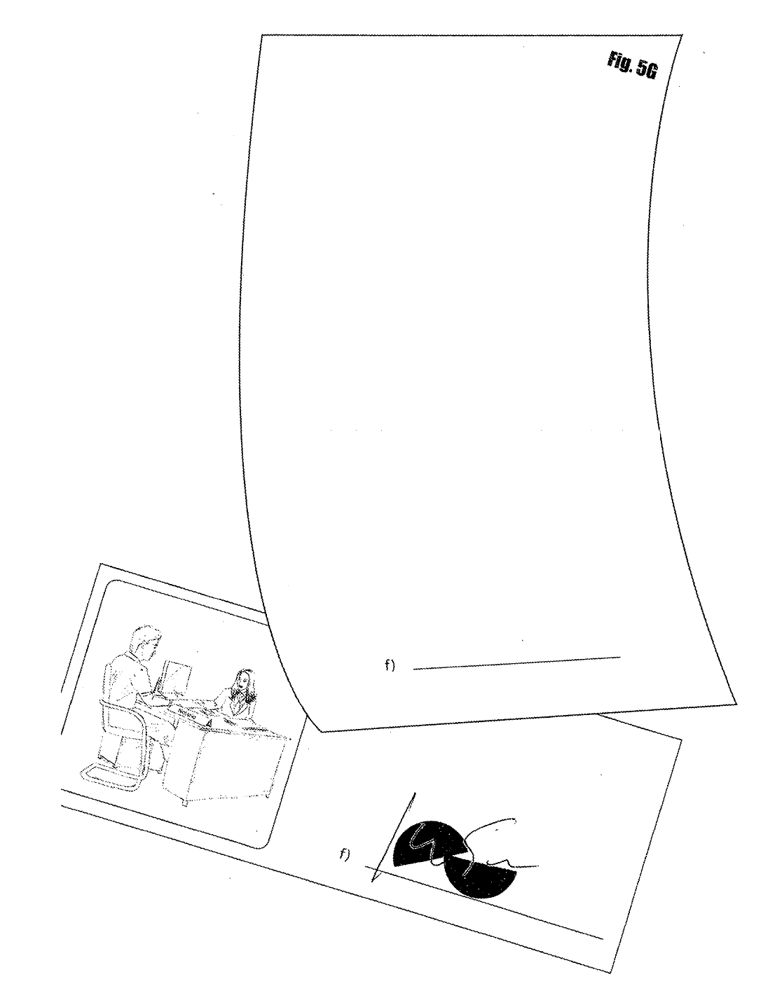

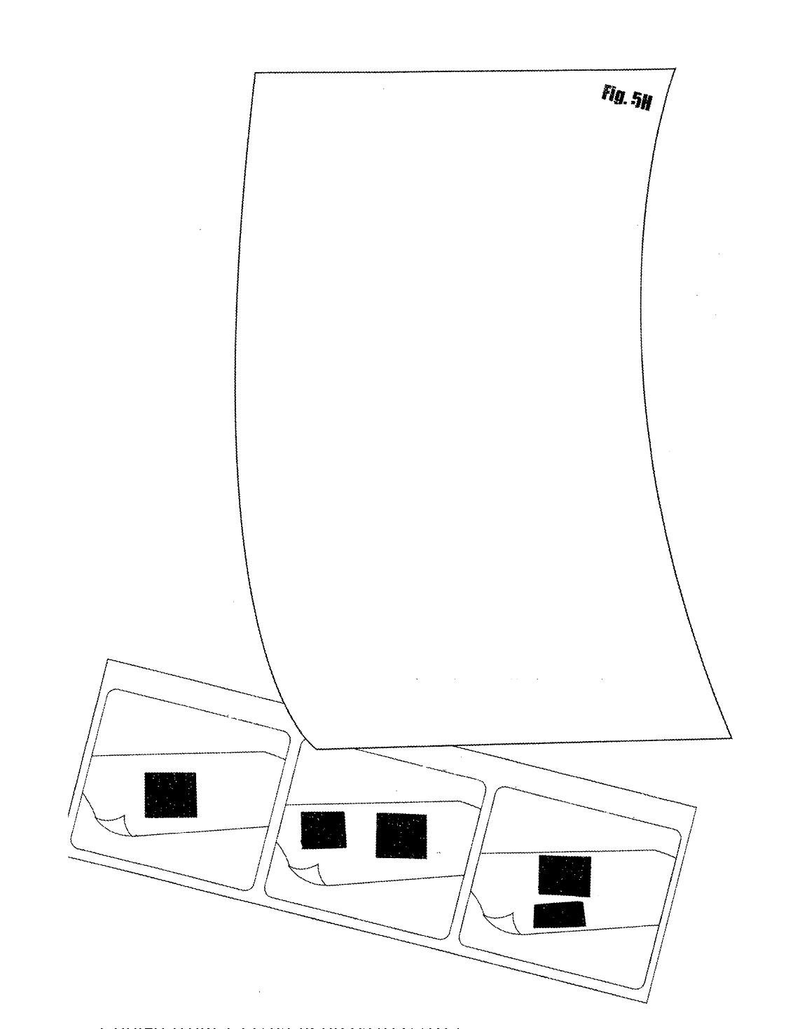

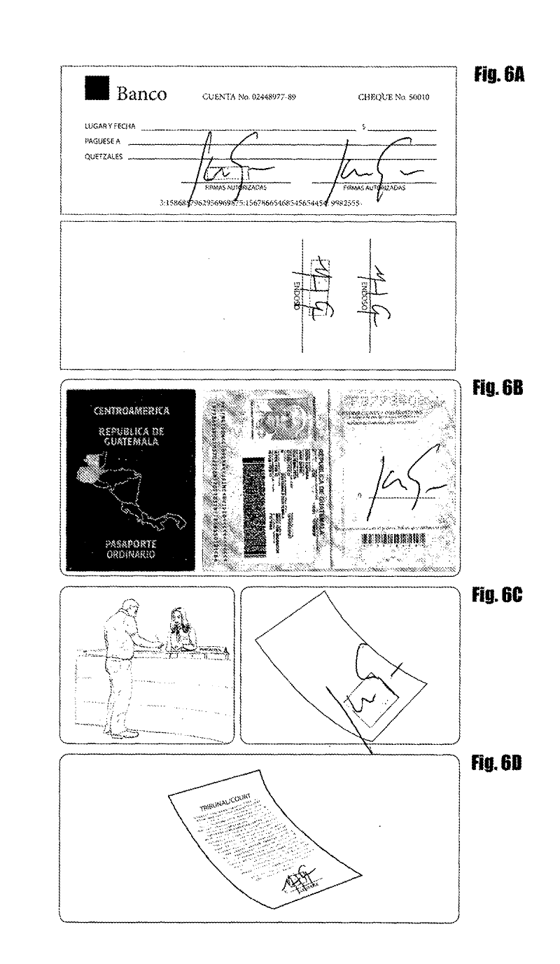

The indubitable signature may be in another document external to the document containing the questioned signature (FIG. 3A), and may be in a digital system as FIG. 3B, 0 on a card signatures like FIG. 3C, 0 on an obstacle like FIG. 3D, or without an obstacle. Signed in situ as in FIG. 3E.

Another embodiment for carrying out the invention is shown from FIG. 4A to FIG. 4E, where there are types of signatures executed without an obstacle and the same executed signatures with different types of obstacles (which are colored for the possible reproduction) with which the utility of the invention is proved.

FIGS. 5A thru 5H demonstrate various embodiments of the use of the obstacles in the documents and methods of signing.

Examples explaining some applications of the invention are made with three different illustrations, wherein the first represents a bank check where the owner of the account re-signs on an obstacle stuck on the document, as shown in FIG. 6A, and likewise, who can endorse again on an obstacle. At a point of Immigration control of any country, the immigration officer as shown in FIG. 6C can verify that the international passport in FIG. 6B is signed on an external support as shown in FIG. 6C and the immigration officer can accept or deny entry of the traveler into the country. A judicial decision where the judge signs on the obstacle to allow a possible subsequent verification that it is effectively the court signature is shown in FIG. 6D.

### DETAILED DESCRIPTION

The claimed invention, including the procedure consisting of signing over one or more obstacle(s) placed and stuck on a document manually or mechanically in a place where the document is required to be signed in order to be visaed, or in another external support of such document that is required to be signed in order to be visaed, where the mentioned obstacle(s) produces at least one physical step/obstacle that causes a physical resistance in the advance of the ink instrument used to sign. Such a signature must be affixed in situ over such obstacle(s), and the result to affix the signature over the obstacle(s) is collated against the indubitable signature of the person whose signature authorizes or approves the content of the document to be visaed, and this procedure can be repeated the number of times that the signature inspector deems convenient. It is possible to affix the signature over the obstacle(s) for “a posteriori” analysis, too.

Such obstacle(s) are placed and manually or mechanically stuck on the place on the document that is to be signed at a suitable distance if it is placed by hand or with a calculated distance if it is placed mechanically. More than one step can be created with such obstacle(s) affixing one over the other or one separated from the other, the specific size of the obstacles and the number of obstacles depending on the size of the signature and also on the person who will apply the procedure. The distance in which the obstacle(s) will be placed and stuck also can depend on the size of the document to be signed. The obstacle(s) can be placed and stuck previously by hand or mechanically, or can be placed and stuck at the moment of signing, even after signing of the document, with the purpose to authenticate the signature one more time, if the signature inspector deems it convenient. The order and/or the position in the document in which the procedure will be carried out do not alter or change the results.

The signature affixed over the obstacle(s) will be collated against the one that is considered an indubitable signature.

Being able to be considered an undoubted signature can be (A) the one that is previously registered on any other media or support on one or more obstacles, or only on the blank corresponding area in such media or support, (B) the signature that is already affixed on an obstacle(s) in the original document, (C) the signature that is already affixed initially on the corresponding space in the same document to be visaed, (D) the questioned signature itself, i.e., the one that the signer has just affixed on the corresponding space in the same document to be visaed before the signature inspector, and (E) the first signature that the signer just has written.

The material and thickness of the obstacle(s) can be of any kind and color or transparent, such decision depends on who will carry out the procedure.

The procedure also can use any type of ink instrument to write, of any kind color and of any type of ink.

To obtain different levels of analysis, the signature can be superimposed on an obstacle or obstacles to produce different levels of steps/obstacles to affix the signature in situ or to affix the signature in a document at any moment to be used as indubitable signature in any time. Then, the obstacle(s) can be placed and stuck in the middle of the signature, and it can be a square, round, rectangular or any symmetrical or asymmetrical geometric shape, depending on which is the use and the level of results that the user wishes to obtain. The present invention also can be depending on the size of the signature to be visaed, and the obstacle can be of any thickness, causing a step.

Consequently, the purpose of the invention is to provoke the notoriety of a signature fixed on a document which, if such signature turns out not their own hand-written signature affixed by him/her because it is a false or fraudulent signature, it may cause injury to the person who is authorized to sign such document. Likewise, the act to accept such document as valid for the signature affixed can cause damage to a third party or to a public authority if the signature is false.

To solve this current problem, the claimed invention proceeds to cause such notoriety as to make clear evidence of the signature to be analyzed using the structure of the doubtful signature, to compare such signature with the structure of the undoubted signature that is previously registered in any way. For such effect, the procedure uses the obstacle(s) that are placed and stuck to the document to be visaed (or are placed and stuck in another external support of the document to be visaed) to produce at least one step that itself consists of an artificial obstacle to the person who signs that causes stops and shakings in his/her handwriting that constitute the particular features and fundamental facts of the handwriting identity of the original signer. The physical resistance caused by such obstacle(s), the reason of the invention, can be corrected only by the original signer in the set of features of general and individual order that forms the structure of his/her signature, pursuant to which the invention clearly evidences if there are dissimilarities, divergences, overlaps or identification in the natural performance from the beginning to the end of the some handwriting strokes, that allows a person who is not an expert to be able to conclude in situ if the morphological-dimension of the evaluated signatures are or are not affixed by the same person, and such procedure of the invention allows the signature inspector to observe at first glance and assess directly the signature submitted for approval or consent, and such assessment can be concluded in real time. Whether or not there is doubt can be reasoned if there are similarities or similitudes with the authentic signature and therefore, the signature inspector can deny or accept the document to be visaed, without the signature inspector being a handwriting analysis expert.

In summary, the invention allows handwriting analysis of the signature, in an effective, simple and easy way at low cost and quickly, in real time, to compare one indubitable signature with a questioned signature performed with physical and mental inconvenience (e.g., pressure to do the signature when it is done before the signature inspector), and make the best decision regarding the validity of the signature and/or signer. The invention may be applied in any human activity at any time in any country in any language that needs to visa a document (that requires it to be signed) in order to accept or deny the signature as authentic or invalid. The invention is intended to prevent fraud in its fullest extend by allowing analyzing with the naked eye a questionable signature, and accurately concluding if it is to be denied or accepted without being an in expert on the field and in real time.

From things relative to handwriting analysis, the claimed invention is effective to different technique propositions of the subject, and consequently:

1. With regard to the laws of handwriting analysis expounded by Solange Pellet, the claimed invention allows a person to submit his/her signature for examination in any language based on the signature resulting directly from the cerebral impulse of the evaluated person. It hinders the effort that cannot be performed slowly because it “crashes” with the step of the obstacle. Therefore, the claimed invention constitutes an important tool since it consists in itself of a particularly difficult condition requiring that the handwriting strokes of the signature be the one of the person who must sign the document, and this not only hinders the masking of one's own signature, but also prevents imitation of the signature of a third party. These issues are difficult with the invention in real time, since it potentiates the action of the authentic signer as well as accentuates the individuality of the handwriting.
2. Regarding the theories of Ludwing Klages, the claimed invention impedes copying of the signature of a third person since the invention obligates the expression of the person who executes the signature, without being able to subtract the involuntary and instinctive acts; it hinders inner figuration that raises the unconscious wait of the presumed result of the movement; it highlights the performance of the most apparent handwriting strokes, allowing observation with the naked eye, whether denoting a false signature, a simulated signature or anemography signature; and it makes it difficult to modify the curve and angular handwriting. When the person who signs forces the effort to sign, he/she will evidence the individualization of the forgery; it causes difficulty for the voluntary control when he/she writes, and it potentiates the individuality of the speed, extension and pressure of the person who affixes the signature.
3. The claimed invention also hinders the similarities, making more insufficient the similarities to demonstrate the authenticity of the signature.
4. Regarding some statements of Saudek, the claimed invention allows a signer to submit to exam the signature of the person under the fundamental principle of Saudek, that nobody is able to imitate at the same time, in the handwriting of another person, these five elements of writing: a) wealth and variety of form; b) dimension (calibro); c) linkage; d) inclination; and e) pressure.
5. Regarding the observations of Moretti, the present invention, which is only a test whose principal rule is the common sense of the person who evaluates the signature (the signature inspector) can somehow objectively cause an effect within the various moods of the signer, since he/she has to do his/her signature in a concentrated manner and for a specific subject, and at the same time, it presses on his/her mood if his/her intention is masking his/her signature or the simulation of the signature of a third party, which will be apparent to one who examines the signature.
6. Regarding the process that leads the handwriting build up by several functions such as language, motor function, emotions, etc., the present invention has presence in the organization on the desk space of the ductus, being it the center of the set of all movements necessary for the act of signing, both preparatory movements such as the approach of the ink instrument to the sheet with the obstacle and the operating movements which comprise the movements of paper separation and the step that produces the obstacle, by several suspensions and spaces between one letter and another and between words, the points, the “t” cuts, the punctuation to link parts of the successive letters, etc. The claimed invention induces the stroke that appears difficult as the ductus of the set of movements used to obtain the strokes.
7. The result of the claimed invention is not altered by the characteristics of the writing of the signer, such as age, gender, culture, nationality, profession or left-handed writing features.
8. The invention is an expert operation that uses the natural perception of the person who examines a questionable signature when the examiner is not a handwriting analysis expert, and for the person who is an expert in handwriting analysis, this invention is one more tool of analysis.
9. The invention resizes the features of a letter that a person has affixed in his/her signature, which allows the graphology to decide whether or not to accept a questionable signature as an indubitable signature.
10. The invention itself is always an original document that individualizes the handwriting, the paper used and a suitable support surface, avoiding the presence of cancellations, additions, retouching, tweaks and substitutions, which intensifies the observation of the signature path to visa the graphic level and particularly the spontaneity and nature of the signature.

In conclusion, the claimed invention synthesizes expertise so that a non-expert in handwriting analysis may assess with the naked eye a comparative analytical study with a signature over an obstacle, since the invention highlights the comparison of: similarities, analogy and identity of signals, but mostly, the graphic signal as a whole and the print of the signature who performs it; the invention allows a final judgment that brings to attention the following facts to the naked eye of the person who evaluates the signature:

a. The nature and spontaneity;

b. The quality of the features (connoted), including whether it is just one;

c. Mismatch;

d. Significant differences;

e. Any qualitative difference;

f. The compatibility or incompatibility graphological and gestural;

g. Highlight symptoms of sincerity and authenticity probably related to the speed, balance and harmony of the set, the vitality appearance that the signature produces;

h. Highlights the fake regarding to the symptoms of lack of sincerity and then the symptoms of a probable fake signature, related to the slow, disharmony of the set, the signs of insecurity, frequent retakes, of his/her left hand, lack of vitality and preventing retouching;

i. The present invention will highlight a fake signature by distortion of the signature when someone is masking his/her own signature, and also when someone wants to imitate the signature of another person;

j. The invention prevents imitation by direct tracing transfer or by indirect tracing, since the obstacle does not allow a person who is signing to do such tracing; and also prevents imitation by cutout composition and photomontage;

k. The invention intensifies the rates of recognition of a fake signature, including the imperfections of the track, jams, agitations, delays, ascending the faint tremor, fine detail to observe and copy the model, abnormal interruptions, the retakes, retouching, correcting the bad strokes facts, scratching, and excessive identity with the authentic signature;

l. The invention intensifies rates of falseness such as tremors, slow, lateral infiltration of ink, interruptions or suspensions in the layout, loads of inks, the two dots on the “i”, too much care, brief signature, the identity of superimposed paths, retouching in upper extension cords, undulations or variations in the height of the letters, and the limited availability to give samples.

Some areas of the Claimed Invention:

1. In the financial area, in any bank or financial instruments of any type, that need to be signed for authorization, acceptance, issuance, collection and/or endorsement, such as documents in deposit transactions, current accounts, certificates of all kinds, obligations of any kind, portfolio titles and all other types of credits, debits, domestic and foreign operations, and estate, trust and collateral operations, cash receipts and payments for third parties, safety deposit boxes, cashiers checks as well as management and any other type custody and administration of values, collection of government taxes of any level and type, collateral transactions such as leasing, factoring and confirming forfeiting, investment funds, fiduciary activities, credit and debit cards, as well as documents to be signed on insurance policies of any kind, bonds of any type and checks of any type.

2. In the legal area, in any public and/or private legal instrument with effect on third parties for any type that needs to be signed for authorization, acceptance, registration statement, issue, notice, certification, etc., such as in documents containing any type of judicial decisions, orders and court reports, authentic signatures, affidavits of any kind, legal settlements of any kind, books or sheets of judicial control; contracts, deeds of any kind and nature, any kind of wills, property records of any kind; civil area registrations, cancellations, extensions, certification as birth, marriage, divorce, and death, among others.

3. In the diplomatic area, in any diplomatic instrument of any kind that needs to be signed for authorization, acceptance, registration statement, issue, notice, certification documents such as, among others: a) passes control law, legalization of foreign documents with effect in its territory; b) the signature of agreements between governments; c) control of the international passport valid through the stamped signatures of the handwriting of those who carry it.

4. In the commercial area, in any commercial instrument of any kind required to be signed for authorization, acceptance, registration statement, issue, notice, certification, such as in documents for; a) Meetings of Shareholders; b) commercial records; c) share certificates; d) Form Companies Registration; e) employment relationship; f) contracts and business titles of all kinds; g) Cut Sheet and/or carrying of employment assistance; h) commercial resolutions and certifications; i) actions contained in commercial books of all kinds; j) issuing and receiving invoices, purchase order, sales order, receipt of goods, claims, refunds, shipping notes, returns, and passwords of any kind, among others.

5. In the governmental area, in any governmental instrument of any level, of any type, that needs to be signed for authorization, acceptance, registration statement, issue, notice, certification, such as documents containing any government and/or administrative resolutions; agreements, orders, certifications and government reports and/or administrative; agreements, orders, certifications and government reports and/or administrative provisions of any kind; books or sheets of government control and/or administrative, government contracts and/or administrative deeds and/or deprived of any kind and nature, governmental agreements of any level and any laws or legislative decrees, legislative instrument of any kind, educational qualifications, any tax instruments, forms of social assistance, licenses or permits of any level and any type issued by government agencies, and participation and granting of public contract bid of all kinds.

9. A method of performing an accurate analysis of a handwritten signature with the naked eye by a non-expert in handwriting analysis to authenticate or invalidate the signature, the method comprising:
providing at least one document of any kind to be signed with a handwritten signature;
providing one or more obstacles of any material, size, color and geometric shape;
affixing the one or more obstacles on the document or on one or more obstacles affixed on the document, each said obstacle forming one or more steps, each said step impeding a normal stroke of an ink instrument that is used to sign the document;
providing a handwritten signature with the ink instrument on the one or more obstacles affixed on the document;
providing at least one authentic signature;
visually examining the structure of the handwritten signature on the obstacles on the document with the structure of the authentic signature, and performing a comparative analysis of the precise conformities or disconformities shown in the structure of the handwritten signature to the structure of the authentic signature; and
accurately determining, based on the comparative analysis during the visual examination, if the handwritten signature is authentic or invalid.

10. The method of claim 9, wherein determining if the handwritten signature is authentic or invalid is done in real time with providing the handwritten signature.

11. The method of claim 9, wherein the obstacles are manually affixed.

12. The method of claim 9, wherein the obstacles are mechanically affixed.

13. The method of claim 10, wherein the obstacles are manually affixed.

14. The method of claim 10, wherein the obstacles are mechanically affixed.

15. The method of claim 9, wherein affixing the obstacles, providing a handwritten signature, and visually examining and performing a comparative analysis of the handwritten signature with the authentic signature are repeated to accurately determine if the handwritten signature is authentic or invalid.

16. The method of claim 10, wherein affixing the obstacles, providing a handwritten signature, and visually examining and performing a comparative analysis of the handwritten signature with the authentic signature are repeated to accurately determine if the handwritten signature is authentic or invalid.

17. The method of claim 9, wherein the authentic signature is provided on a support media external to the document to be signed.

18. The method of claim 17, wherein the authentic signature is provided electronically.

19. The method of claim 9, wherein the authentic signature is provided on the document to be signed.

20. The method of claim 9, wherein the authentic signature is provided on one or more obstacles.

21. The method of claim 9, wherein the authentic signature is provided without obstacles.

22. The method of claim 9, wherein the document to be signed contains an alphanumeric reference.
